(19) United States
(12) Patent Application Publication
(10) Pub. No.: US 2009/0281888 A1
(43) Pub. Date: Nov. 12, 2009

(54) Method And Apparatus For Establishing Time-Based Loyalty Relationship

(76) Inventors: Li-Cheng Richard Zai, Los Gatos, CA (US); Xinyu Zang, Palo Alto, CA (US); Sophia Fang-Jung Liu, Cupertino, CA (US); Mao-Jung Chen, Taipei City (TW)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/180,494

(22) Filed: Jul. 25, 2008

Related U.S. Application Data
(60) Provisional application No. 61/127,207, filed on May 9, 2008.

(51) Int. Cl. G06F 3/048; G06Q 30/00; G06Q 50/00

(52) U.S. Cl. 705/14.25; 715/764; 705/14.37; 715/764

(57) ABSTRACT

A method and apparatus that determine a time window based on a presentation schedule for a multimedia content in response to receiving the presentation schedule is described herein. The multimedia content is played according to the presentation schedule at a predetermined location. During the time window, an interactive user interface pattern is presented within a vicinity of the predetermined location. In response to receiving a user input via the interactive user interface pattern, a reward is generated during the time window.

### CROSS-REFERENCE TO RELATED APPLICATIONS

This application is related to, and claims the benefits of, U.S. Provisional Patent Application No. 61/127,207, filed on May 9, 2008 entitled “Methods and Apparatus for Enabling Time-Based Customer Loyalty Programs”, Li-Cheng Richard Zai et al. which are hereby incorporated by reference herein in its entirety.

### FIELD OF INVENTION

The present invention relates generally to data processing systems. More particularly, this invention relates to enabling time-based loyalty relationship at commercial locations.

### BACKGROUND

It can be appreciated that in-store advising systems have experienced rapid growth in recent years. FIG. 1 describes the prior art in-store digital signage system 100, in which a network operation center (NOC) 120 sends data packets or media disks including contents and play lists to local point-of-present (POP) system 160 via content distribution medium 140. Content Distribution Server 126 processes the received contents 122 including media clips, audio files, videos files, and playlists 124 for content scheduling to create digital files or media disks. The content distribution medium 140 could be wired or wireless networks or disk delivery services. A local POP system 160 typically consists of a single-channel media player 162 connected to a single display 164 or a multiple-channel media player connected to multiple displays 168, 170, and 172.

The main problem of this type of prior-art systems is that the in-store infomercials are delivered in one-direction manner, and there is no incentive for shoppers to watch the infomercials. This results in minimal shoppers' attention and ineffectiveness of the infomercials. While the prior-art TV systems may be suitable to the early deployment for in-store advertising applications, it needs to be improved for enhancing its efficacy of advertising at the point-of-presence located at commercial locations.

### SUMMARY OF THE DESCRIPTION

An embodiment of the present invention includes a method and an apparatus determine a time window based on a presentation schedule for a multimedia content in response to receiving the presentation schedule. The multimedia content is played according to the presentation schedule at a predetermined location. During the time window, an interactive user interface pattern is presented within a vicinity of the predetermined location. In response to receiving a user input via the interactive user interface pattern, a reward is generated during the time window.

Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which;

FIG. 1 is a system diagram illustrating an in-store TV system;

FIG. 2 is a system diagram illustrates an exemplary embodiment of a time-based interactive advertising system;

FIG. 3 is a network diagram illustrating one embodiment of a large-scale time-based advertising system;

FIG. 4 is a block diagram illustrating one embodiment of a large-scale time-based advertising system;

FIG. 5 illustrates one embodiment of an integrated local point-of presence system;

FIG. 6 illustrates one example of a data processing system that may be used as an embodiment of an integrated point-of-presence system of the present invention;

FIG. 7 illustrates exemplary data packets inside digital files received at a local POP system according to one embodiment of the present invention;

FIG. 8 is a Sow diagram illustrating one embodiment of a process to build customer loyalty relationship at a local POP system;

FIG. 9 is a timing diagram illustrating one embodiment of establishing a time-based loyalty relationship;

FIG. 10A illustrates an exemplary local point-of-presence system including a Type-I interactive unit according to one embodiment of the present invention;

FIG. 10B is a block diagram illustrating one embodiment of a Type-I interactive unit;

FIG. 11A illustrates an exemplary local point-of-presence system including a Type-II interactive unit according to one embodiment of the present invention;

FIG. 11B illustrates an exemplary local point-of-presence system including a wireless PAN (personal area network) according to one embodiment of the present invention;

FIG. 12 is a block diagram illustrates one embodiment of the a Type-II interactive unit;

FIG. 13 illustrates an exemplary local point-of-presence system including a shopping-car unit according to one embodiment of the present invention;

FIG. 14A is a block diagram illustrating one embodiment of the Type-III interactive unit;

FIG. 14B is a block diagram illustrating one embodiment of a shopping-cart device;

FIG. 15 is a sequence diagram illustrating one embodiment of a Type-III interactive unit polling a shopping-cart device within a PAN network;

FIG. 16 is a sequence diagram illustrating an example of initiating a communication session with a PAN network according to one embodiment of the present invention.

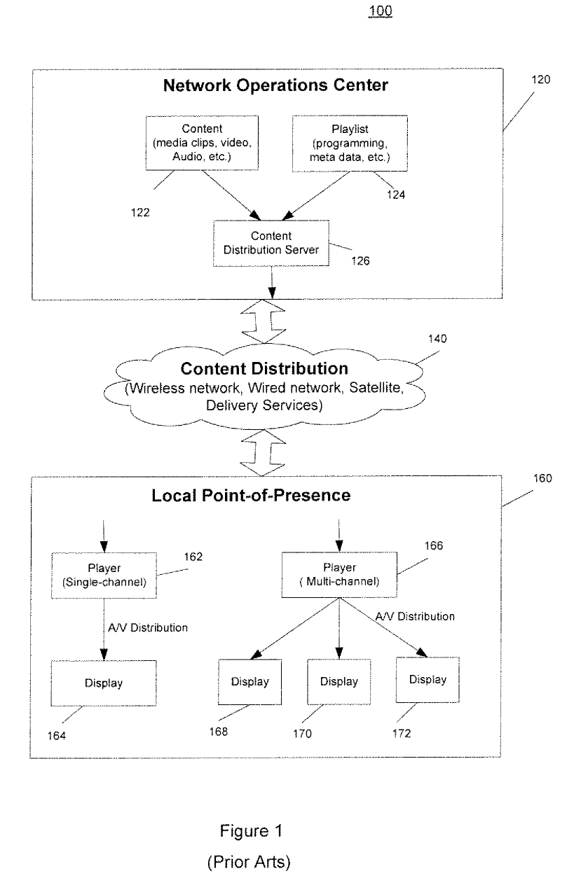

### DETAILED DESCRIPTION

A method and an apparatus for establishing time-based loyalty relationship are described herein. In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

In one embodiment, time-based loyalty relationships is established via interactive, two-way communication in an interactive advertising system including commercial-location equipments integrated with wireless data modems. Network operation centers may communicate with commercial location equipments via wired or wireless wide area networks. Timely credits and/or rewards are generated in response to receiving customer inputs for infomercials, such as one-way or interactive multi media data, presented at commercial locations. Thus, time-based customer loyalties are established according to the programs associated with the presented infomercials.

In another embodiment, a local point-of-presence system may be integrated with dedicated or intelligent media players around commercial locations. Shopping-cart devices may be wirelessly coupled with local point-of-presence systems to collect time-based responses or customer inputs to determine incentives and associated presentations for establishing time-based loyalty relationships,

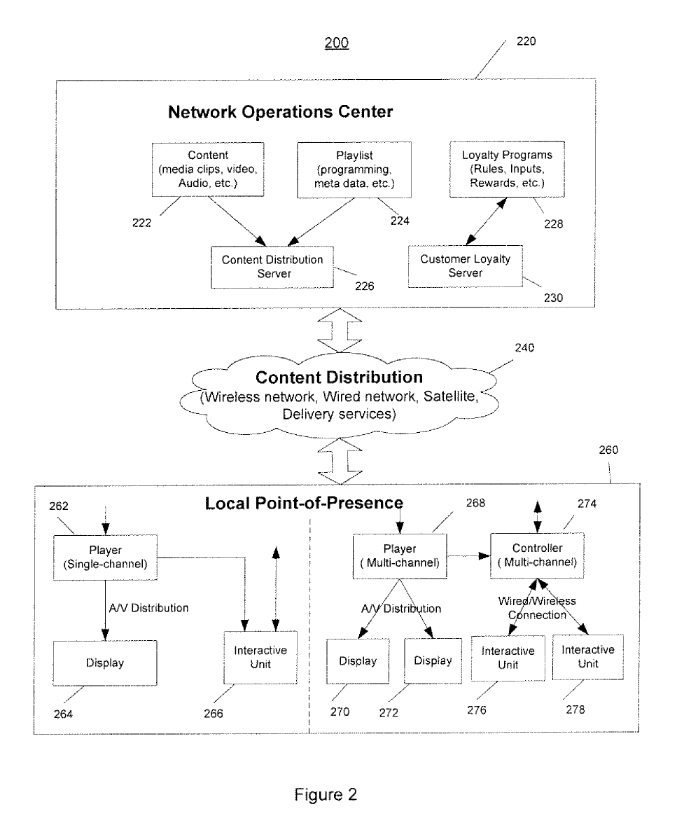

FIG. 2 is a system diagram illustrates an exemplary embodiment of a time-based interactive advertising system. In one embodiment, system 200 includes one or more network operation centers (NOC) 220 coupled with one or more local point-of-presences 260 via content distribution networks 240, such as, for example, wireless networks, wired networks, satellite networks, or other delivery service networks. A deliver service may include disk distribution service. In one embodiment, a network operation center 220 includes one or more content distribution servers 226 and one or more customer loyalty servers 230. Content Distribution Server 226 may process received contents 222, such as media clips, audio files, videos files and/or playlists 224 to create digital files or media disks. A playlist 224 may include programming meta data for scheduling content distribution. In one embodiment, customer loyalty server 230 hosts customer loyalty programs 228 including, for example, membership information, reward rules, and/or received customer inputs corresponding to distributed contents.

According to one embodiment, a local POP system 260 may include a single-channel media player 262 coupled with a single display 264 and/or an interactive unit (IU) 266. A media player 262 may read digital data from digital files or media disks to play multimedia content, such as infomercials to be presented in IO devices such as a display 264 and/or an interactive unit 266. In one embodiment, digital files or media disks include control packets. A media player 262 may send control packets extracted from digital files or media disks to instruct IO devices, such as display 264 and/or an interactive unit 266, to collect user inputs and/or present customer rewards, such as instant coupon or store credit. In another embodiment, a media player 262 may associate content presented in a display, such as display 264, with control/data packets sent to or received from an interactive unit, such as IU 266. An IO device, such as IU 266, 276, or 278, may send collected user inputs or other data back to customer loyalty server 230 either directly or indirectly via a player controller, such as a multi-channel controller 274. In one embodiment, a player is associated with more than one media channels, such as a multi-channel player 268, to present multiple media content at the same time to multiple display devices, such as displays 270, 272. One or more interactive units, such as IU 276, 278, may be associated a display device, such as display 270, 272. A multi-channel controller, such as controller 274, may be coupled with a multi-channel player, such as player 268, to coordinate associations between an IO unit, such as IU 276, 278, and a display, such display 270, 272, such as to synchronize presenting media content to the display and to send/receive data/control packets to/from associated the 10 unit.

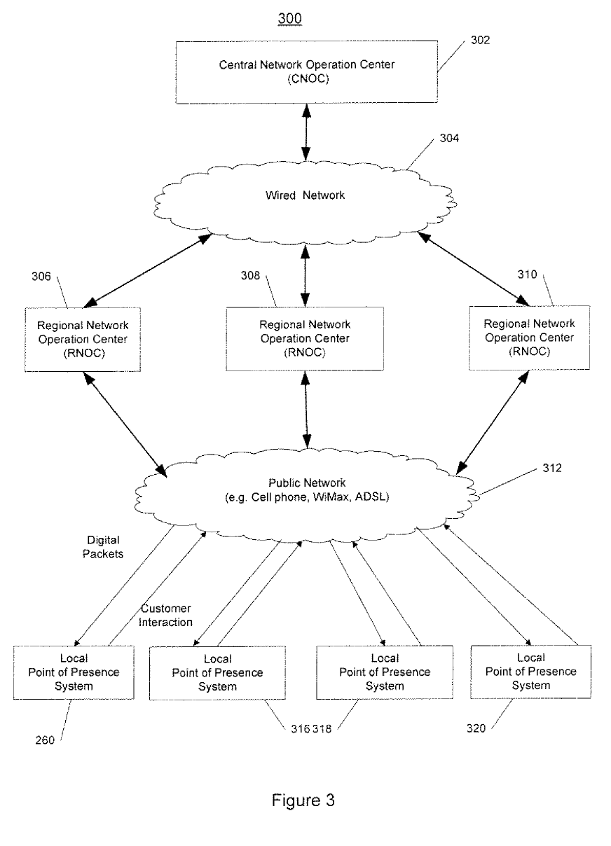

FIG. 3 is a network diagram illustrating one embodiment of a large-scale time-based advertising system. In one embodiment, system 300 includes advertising system 200 as shown in FIG. 2. A central network operation center 302 may be coupled with to one or multiple regional network operation centers (RNOC) 306, 308, 310 via a secure, high-bandwidth data network, such as a wired network 304. Each RNOC may be responsible for the operations of one or more local POP systems, such as POP systems 260, 316, 318, and 320, via a public network 312. A POP system may be stationed in a predetermined fixed location within a commercial property. A content distribution network, such as content distribution 240 of FIG. 2 may include networks 304, 306, 312 and/or 310. In one embodiment, the public network 312 is a cell-phone network or wireless broadband network, such as WiMAX (Worldwide Interoperability for Microwave Access) or ADSL (AsymmetricDigital Subscriber Line) networks, for deploying integrated POP systems independent of information technology (IT) infrastructure at commercial locations.

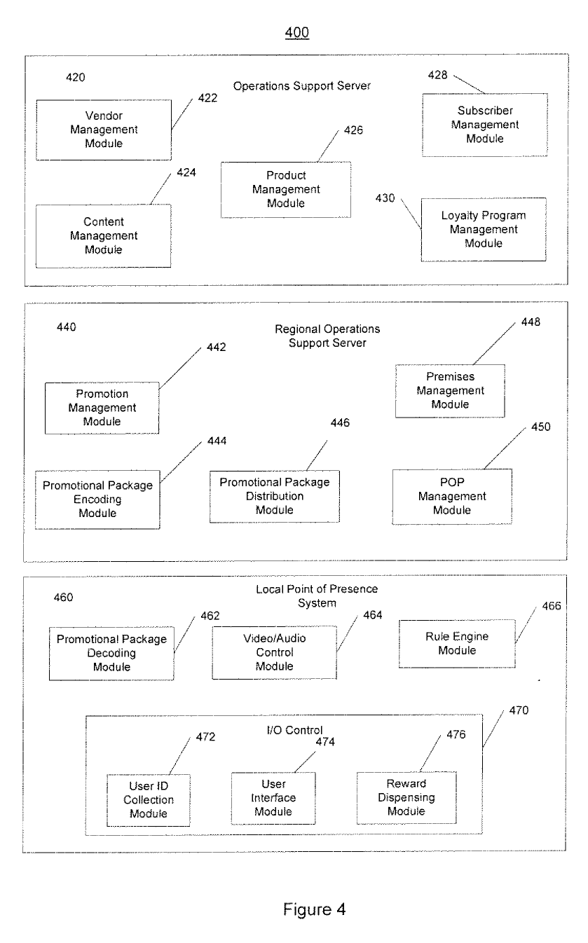

FIG. 4 is a block diagram illustrating one embodiment of a large-scale time-based advertising system. In one embodiment, system 400 includes an operations support server 420 for a central network operation center, such as CNOC 302 of FIG. 3; a regional operations support server 440 for a regional network operation center, such as RNOC 306 of FIG. 3; and a local point of presence system 260. System 420( may include a vendor management module 422, a content management module 424, a product management module 426, a subscriber management module 428, and a loyalty program management module 430. In one embodiment, a vendor management module 422 creates, updates, and maintains structured data for information associated with vendors participating in an advertising system, such as, company names, contacts data, product categories, etc. A content management module 424 may create, update, and maintain the contents and associated meta data provided by the vendors maintained by the vendor management module 422. Each content may be associated with an ID, a name, a description, a type, a date of creation, provider, and/or vendor information. A product management module 426 may create, update, and maintain product files for local POP systems, such as systems 260, 316, 318, and 320 of FIG. 3.

In one embodiment, product files include product information such as a product name, a description, an ID, a price, manufacturer information and universal product codes (UPC) for indexing the products. A subscriber management module 428 may manage (e.g. create, update, and delete etc.) IDs, status, contact information, and credits of each member who subscribes to various loyalty programs. A loyalty program, such as in Loyalty Programs 228 of FIG. 2, may be membership data including a one or more privilege settings associate with binary, numerical and/or string values for each member subscribing to the program. In one embodiment, a loyalty program is associated with executable codes, such as a set of rules, which may generate a value for a certain privilege in real time for a subscriber. A privilege setting in a loyalty program may be associated with a reward value entitled to a subscriber. When a consumer subscribes to a loyalty program, membership information of the consumer may be created for the subscribed loyalty program. A loyalty-program management task 430 may manage (e.g. create, update, delete etc.) loyalty programs. A loyalty program may include specifications for defining a set of rules which determines values of one or more privilege settings, such as reward values, coupon types, valid time period for a reward, etc.

In one embodiment, a regional operation supports server 440 includes a promotion management module 442, a promotional package encoding module 444, a package distribution module 446, a premises management module 448, and a POP management module 450. A promotion management module 442 may define a promotion for a specific product and/or vendor. In one embodiment, a promotion includes a multimedia infomercial content and associated control information, such as a start date/time, a time duration, a scope of target products, associated pricing information for the target products, a type (such as instant coupon, rebates, store credit etc.), a range of rewards/credits values and/or commercial premises or locations where the promotion may be activated. Control information may include specifications of rules from the loyalty programs associated with the corresponding promotion. A promotional package encoding module 444 may convert a multimedia infomercial content of a promotion into digital files as multiple content packets in a multimedia format specified according to media-players located at associated POP systems, such as systems 260, 316, 318 and 320 of FIG. 3. A promotional package encoding module 444 may generate control packets from control information in a promotion. A promotional package encoding module 444 may mix content packets and control packets associated with a promotion or a promotion program to be sent to a POP system.

According to one embodiment, a promotional package distribution module 446 delivers the processed contents, such as content packets and data packets from a promotional package encoding module 444, to a POP system at commercial premises specified by the promotion program. A promotional package encoding module 444 may locate a POP system according to commercial premises maintained by a premises management system 448. In one embodiment, a premises management module 448 creates, updates, and maintains detailed information associated with commercial premises, such as, for example, store IDs, a name, store maps, actual physical locations, network addresses for POP systems stationed within the premises, and/or a list of associated loyalty programs. A POP management module 448 may maintain (e.g. create, update, delete etc.) information about POP systems for commercial premises. In another embodiment, a POP management module 448 may monitor run time statues of POP systems to access the health of POP systems, such as whether a POP system is alive and functioning, current loadings, and/or response times, etc.

In one embodiment, a local point-of presence system 460 includes a promotion package decoding module 462, a video/audio control module 464, a rule engine module 466, and an I/O control module 470. System 460 may implement a local point-of-presence system 260 of FIG. 2. A promotional package decoding module 462 may decode data packets received from a regional operation support server 440. Data packets may be encoded with both content packets and control packets associate with a promotion. Decoding data packets may include separating control packets from content packets. In one embodiment, a promotional package decoding module 462 sends decoded control packets to a rule engine module 466, a video/audio control module 464, and/or an I/O control module 470. In the meanwhile, at substantially the same time, a promotional package decode module 462 may send decoded content packets a video/audio control module 464 to play the content packets via an I/O control 470 according to received control packets, such as start time and durations.

A rule engine module 466 may define a set of rules based on specifications from loyalty programs as received in the control packets from a promotional package decoding module 462. Rules in a rule engine module 466 may determine whether to issue rewards either in the form of credits or instant coupons based on time-based user inputs. A credit may be accorded in real time directly into a user's account, such as a cell phone account in response to user inputs. An instant coupon may be in the form of physical paper, e.g. printed from a printer, or electronic data, e.g. stored in a user's cell phone, hosted accounts or other mobile devices. In one embodiment, a time-based user input is received from an I/O control 470 within a time frame specified in control packets (such as start time and duration, etc.) encoded from a loyalty program. An I/O control module 470 may include a user ID collection module 462, a user interface module 474 and a reward dispensing module 476. A user ID collection module may ensure user inputs are associated with user IDs and present user interface for collecting user IDs when detecting unidentified user inputs. A user interface module 474 may collect user inputs according to the timing information encoded in the control packet. A reward-dispensing module 476 may activate a rule engine module 466 to determine rewards, such as instant coupons or credits, to present to a user according to time-based user inputs received.

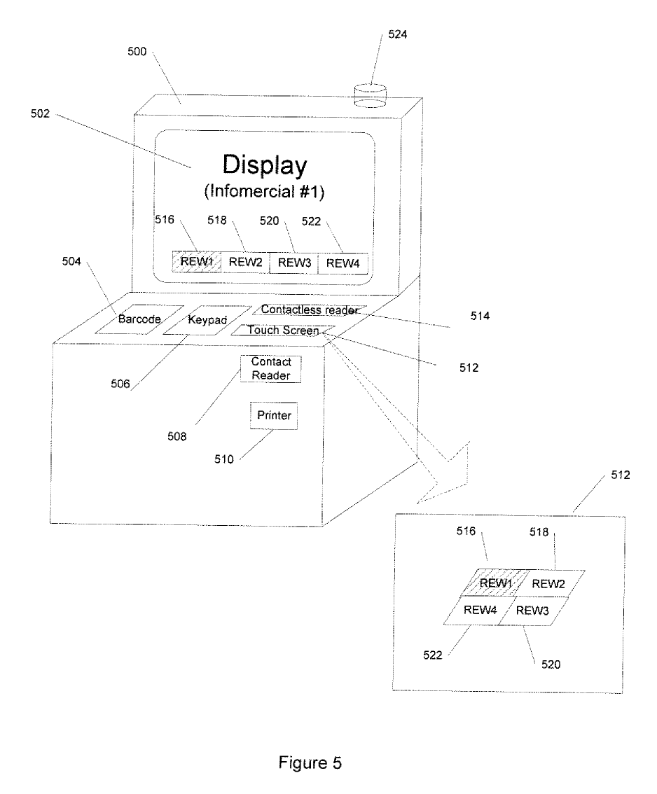

FIG. 5 illustrates one embodiment of an integrated local point-of-presence system. An integrated POP system 500 may be a local POP system, such as system 460 of FIG. 4. In one embodiment, system 500 includes one or more I/O devices controlled via an I/O control module, such as I/O control 470 of FIG. 4. All I/O device in an integrated POP system 500 may be a display device 502, such as a LCD (Liquid Crystal Display) monitor or HDTV (High-Definition Television), a barcode scanner 504, a keypad 506, a contact card reader 508, a contactless card reader 514, a touch screen 512, and/or a printer 510. A barcode scanner 504 may scan data printed in a barcode format, such as a membership ID or product pricing information. A contact card reader 508 may interface with a contact card with magnetic stripe or smart IC to retrieve user information and/or output credit information. To support wireless transactions, a contactless reader 514 may read and write data into cards integrated with RFID (Radio Frequency Identification) or NFC (near-field communication) integrated circuits.

In one embodiment, a touch screen 512 displays multiple reward symbols 516, 518, 520, 522 for different products. A touch screen 512 may be separate from or a part of a display screen 502. A reward symbol 516 may blink to indicate its associated audio/vides content is being shown on a display 502. Conversely, reward symbols 518, 520, 522 may include static images to indicate their associated audio/video contents have already been played before. Printer 510 may print out the rewards, such as instant coupons, for users. In one embodiment, an indicator 524 is a light emitting device that blinks to attract users' attention for a special promotion event, such as a sweepstake event.

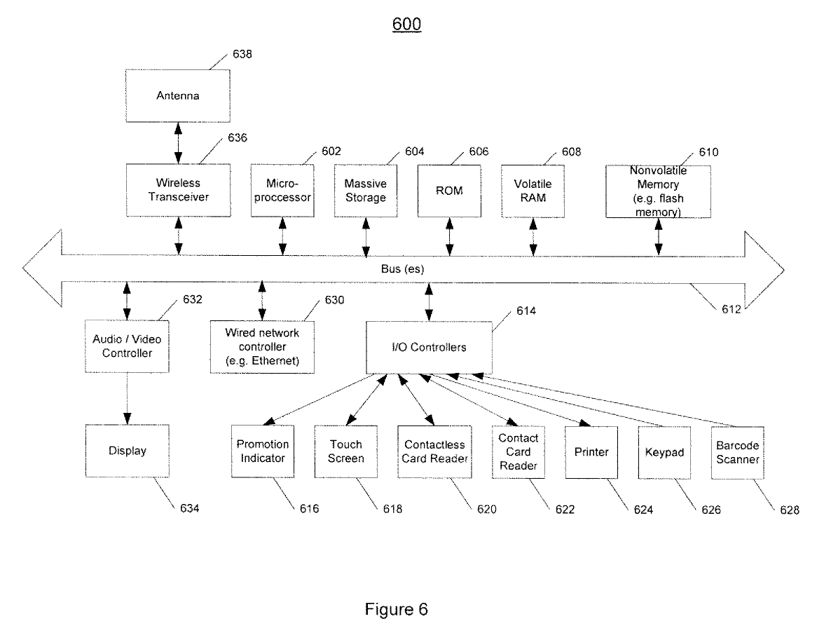

FIG. 6 illustrates one example of a data processing system that may be used as an embodiment of an integrated point-of-presence system of the present invention. For example, the system 600 may be implemented as a part of the system shown in FIG. 2. Note that while FIG. 6 illustrates various components of a computer system, it is not intended to represent any particular architecture or manner of interconnecting the components as such details are not germane to the present invention. It will also be appreciated that network computers and other data processing systems which have fewer components or perhaps more components may also be used with the present invention.

As shown in FIG. 6, the system 600, which is a form of a data processing system, includes a bus 612 which is coupled to a microprocessor(s) 602, a massive storage device 604, a ROM (Read Only Memory) 606, a volatile RAM 608, a non-volatile memory 610 and a wireless transceiver 636. The microprocessor 602 may retrieve the instructions from the memories 606, 608, 610 and execute the instructions to perform operations described herewith. The bus 612 interconnects these various components together and also interconnects components 636, 602, 604, 606, 608 and 610 to an antenna 638, a display device 634, and I/O devices which may be a promotional indicator 616, a touch screen 618, a contactless card reader 620, a contact card reader 622, a printer 624, a keyboard 626 and/or a barcode scanner 628. A display device 634 may be coupled to the system through an audio/video controller 632. The microprocessor 602 may execute instructions to play infomercial messages on display 634 through an audio/video controller 632 via bus 612. Typically, I/O devices are coupled to the system through I/O controllers 614. A typical contact or contactless card reader may perform both read and write operations.

System 600 may be coupled to a wired network, such as Ethernet, through a wired network controller 630. Additionally, system 600 may include an interface to a wireless network via an antenna 638 through a wireless transceiver 636. In one embodiment, a wireless transceiver 636 is a cell phone network transceiver enabling system 600 to establish connections to a RNOC 306, 308, 310 of FIG. 3 via a cell phone operator center. In another embodiment, a wireless transceiver 636 may be a radio frequency (RE) transceiver (e.g., an RF transceiver for a ZigBee wireless network or a Wi-Fi transceiver for IEEE 802 based wireless network).

The mass storage 604 is typically a magnetic hard drive or a magnetic optical drive or an optical drive or a DVD RAM or a Sash memory or other types of memory systems which maintain data (e.g. large amounts of data) even after power is removed from the system. Typically, the mass storage 604 will also be a random access memory although this is not required. While FIG. 6 shows that the mass storage 604 is a local device coupled directly to the rest of the components in the data processing system, it will be appreciated that the present invention may utilize a non-volatile memory which is remote from the system, such as a network storage device which is coupled to the data processing system through a network interface such as a modem or Ethernet interface or wireless networking interface. The bus 612 may include one or more buses connected to each other through various bridges, controllers and/or adapters as is well known in the art.

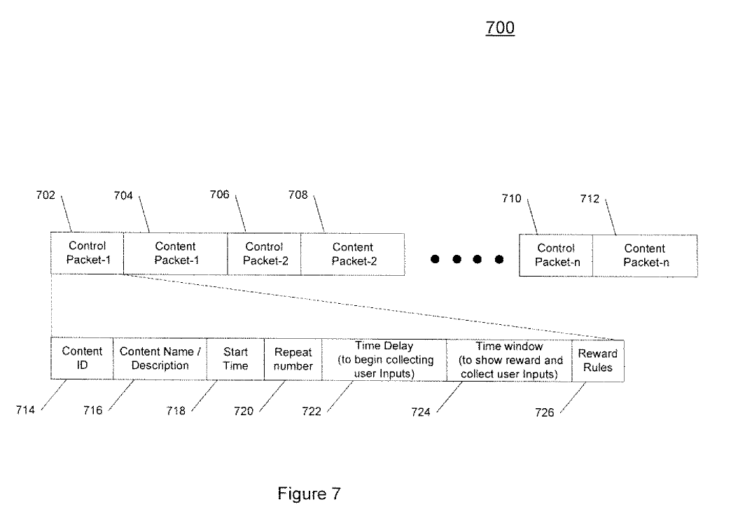

FIG. 7 illustrates exemplary data packets inside digital files received at a local POP system according to one embodiment of the present invention. A digital file may include one or more pairs of control packets 702, 706, 710 and content packets 704, 708, 712. Content packets 702, 706, 710 may be presented via I/O devices of a local POP system, such as display 264, 270, 272 of FIG. 2. Control packets 702, 706, 710 may configure a local POP system to collect user inputs and issue user rewards, such as, for example via a rule engine module 466 and an I/O control 470 of FIG. 4. In one embodiment, a control packet 702 includes a content ID field 714, a content name and description field 716, a start time field 718, a repeat number field 720, a time delay field 722, a time window field 724, and a reward rule field 726. A content ID 714 may be a unique number identifying a content packet 704 associated with a control packet 702. A content name and description field 716 may include a name and a short description of a content packet 704. A start time field 718 may indicate a time for configuring a local POP system when to present a paired content packet 704. A repeat number field 720 may indicate the number of times that a content packet 704 should be repeatedly played/presented. A time delay field 722 may indicate a delay between the start time of presenting a content packet 704 and the time to start collecting user inputs. In one embodiment, this time delay is a few seconds to allow a user to view the content packet 704 before the user can enter his inputs. A time window field 724 may control a time window for collecting user inputs and issuing rewards that are associated with a content packet, such as, for example, content packet 704. In one embodiment, a time window spans through the showing time to present/play more than one content packets, such as, for example, content packets 704, 708, 712. A reward rule field 726 may control how the reward should be issued. In one embodiment, the reward is an instant coupon in either electronic or paper formats with an authorization allowing a user to redeem it at the cash registers. In another embodiment, the reward may be customer loyalty points generated for a user's account. Loyalty points may be accumulated in a users account and redeemable at a later time.

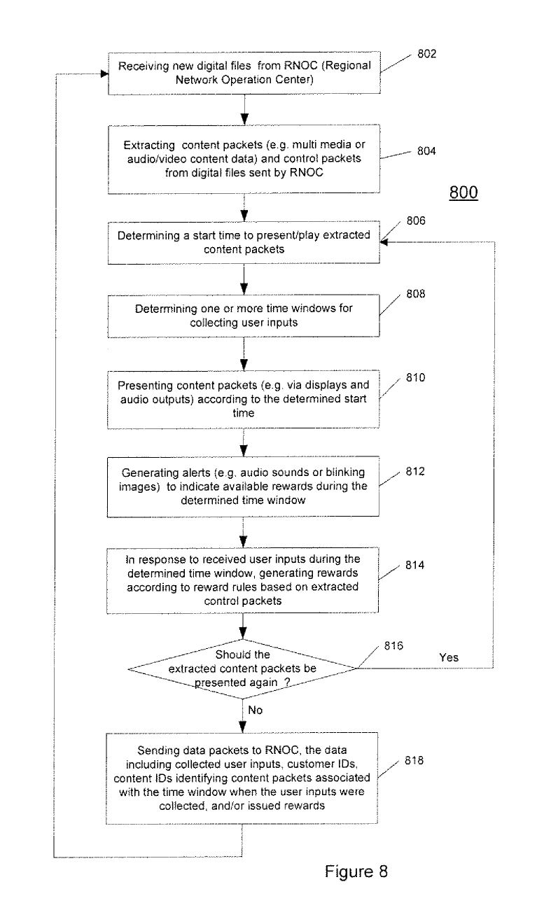

FIG. 8 is a flow diagram illustrating one embodiment of a process to build customer loyalty relationships at a local POP system. Exemplary process 800 may be performed by a processing logic that may include hardware (circuitry, dedicated logic, etc.), software (such as is run on a dedicated machine), or a combination of both. For example, process 800 may be performed by some components of system 600 of FIG. 6. At Block 802, the processing logic of process 800 may receive digital files from a network operation center, such as RNOCs 306, 308, 310 of FIG. 3. A digital file may be pushed out from a network operation center. Alternatively, a digital file may be received in response to a request sent to a network operation center. At block 804, the processing logic of process 800 may extract from a digital file control packets, such as control packets 702, 706, 710 of FIG. 7, and/or content packets, such as content packets 704, 708, 712 of FIG. 7. A control packet and a content packet may be encoded in a digital file according to a predetermined format.

In one embodiment, at block 806, the processing logic of process 800 determines a start time to present or play content packets, such as a multi medial or audio/video infomercial. Control packets associated with a content packet may include a start time for presenting the content packet. A content packet in a digital file may be associated with a control packet extracted from the same digital file. In another embodiment, a control packet may be associated with a content packed based on a common identifier. A start time may specify a schedule, e.g. at the hour between 10:00 am to 3:00 pm daily. In one embodiment, a start time depends on one or more triggers, such as detection of presence of viewers within a vicinity area of a POP system receiving user commands, and/or simply the reception of an associated control packet for a content packet. For example, a detection within a vicinity may be based on an establishment of an REID (Radio Frequency Identification) wireless network between a POP system and a mobile device associated with a viewer. A control packet may include constraints specifying the types of triggers and associated active time schedule with a trigger.

At block 808, according to one embodiment, the processing logic of process 800 may determine one or more time windows for collecting user inputs. A time based loyalty from a user or customer may be established during a determined time window when user inputs are honored. A time window may indicate a time period including a beginning time and a length of the time period. User inputs may be collected according I/O devices, such as a touch screen 618, card readers 620, 622, a keypad 626 or a barcode scanner 628 of FIG. 6. In one embodiment, a beginning time of a time window for collecting user inputs is determined based on a start time to present a content packet and a delay, e.g. predetermined or included in a control packet. A delay between a start time to present a content packet and a beginning time to collect user inputs may be dynamically adjusted according to, for example, a history of the response time, a history of response rates, and/or current time of the day. In another embodiment, a time window may start earlier than a presentation of a content associated with the time window begins. More tan one time windows may be determined during the time a content packet is presented/played.

At block 810, the processing logic of process 800 may present/play content packets to an output device, such as display 264 of FIG. 2, according to a start time determined at block 806. In one embodiment, during the time window determined at block 808, the processing logic of process 800 generates alerts to indicate available awards at block 812. An alert may include an image blinking on a display device, such as REW1 516 on display 502 of FIG. 5. In one embodiment, an alert includes an audio output via a video/audio control module of a POP system, such as control module 464 of FIG. 4. A user input may be collected via interactive devices, such as interactive units 266 of FIG. 2. Collected user inputs may include identifiers associated with a user, such as a customer ID. In response to received user inputs, according to one embodiment, the processing logic of process 800 may issue one or more rewards at block 814. Rules according to control packets, such as control packets 702, 706, 710 of FIG. 7, may be applied, e.g. via a rule engine module 466 of FIG. 4, to determine which rewards, for example, instant coupons or store credits, to issue for a received user input. The processing logic of process 800 may receive user inputs directly via a POP system or from an interactive device separately coupled to a POP system via wired or wireless network, such as interactive unit 266 of FIG. 2. In one embodiment, the processing logic of process 800 updates alerts or stops sending alerts for a period of time within the time window determined at block 808 subsequent to issuing rewards in response to user inputs. For example, an amount of available rewards indicated in an alert may be reduced.

The processing logic of process 800 may determine whether to repeat presenting a content packet, such as content packets 704, 708, 712 of FIG. 7, at block 816. A control packet associated with a content packet may indicate, for example, a repeat number as the number of times presentation of the content packet should be repeated. In one embodiment, the processing logic of process 800 updates a play number as the number of times a content packet has been played subsequently to a completion of a presentation/play of the content packed. If the play number is less than the repeat number, the processing logic of process 800 may determine to continue re-run a content packet at block 806. Otherwise, the processing logic of process 800 may send the collected user inputs including customer IDs, content IDs identifying content packets being played when corresponding user inputs were collected and records of issued rewards to a network operation center, such as RNOC 306 of FIG. 3.

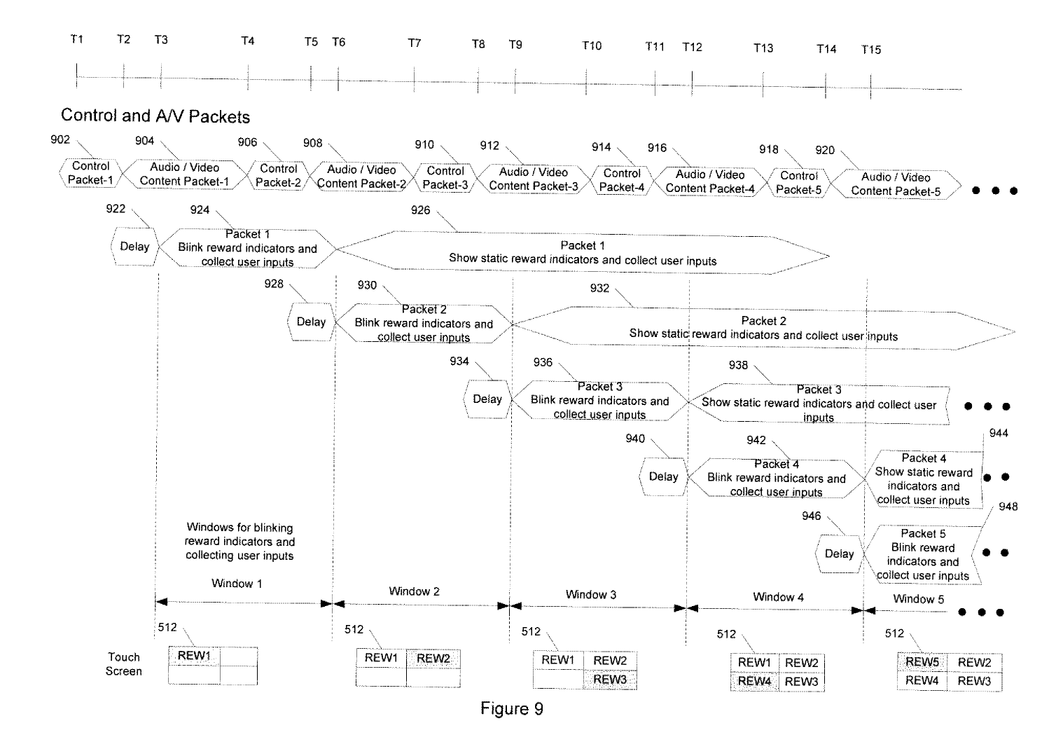

FIG. 9 is a timing diagram illustrating one embodiment of establishing a time-based loyalty relationship. A series of paired control packets 902, 906, 910, 914, 918 and content packets 904, 908, 912, 916, 920 may be received at a POP system, such as system 500 of FIG. 5, in a concatenated manner as decoded from digital files sent from a network operation center, such as RNOC 306 of FIG. 3. Each pair of control packet and content packet may include an infomercial from a vendor such as an advertising company or a product manufacturer. Starting at time T1 during time period 902, a POP system may decode a control packet-1. Starting at time T2 during time period 904, a POP system may play content packet-1 associated with control packet-1. A POP system may determine a time window for collecting user inputs, e.g. via touch screen 512 or keypad 506 of FIG. 5, as time period 924 starting at time T3 according to a delay 922 with respect to time T2 when presentation of an associated content packet-1 commences. In one embodiment, during a time window of period 924, a POP system blinks a reward pattern associated with content packet-1 on a touch screen display, such as REW1 516 on display 502 of FIG. 5. A reward pattern may be a user interface pattern for receiving a user input. A delay time period of duration 922 after presentation of content packet-1 starts may be determined according to control packet packet-1 to allow a user enough time to view and listen to the presentation of content packet-1 before entering inputs. On receiving valid user inputs during a time window of duration 924, a POP system may display earned credits and/or generate an issued reward, such as an instant coupon, to a user.

During the time period between T4 and T9, a POP system may repeat similar operations for control packet-2 and content packet-2 as for control packet-1 and content packet-2 during the time period between T1 and T4. For example, a reward pattern REW2 518 associated with content packet-2 may be presented on display 502 of FIG. 5 in a blinking manner during the time period between T4 and T9. A POP system may receive user inputs during a time window of duration 930 in response to presenting reward pattern REW2 518. In another embodiment, different alerts may be associated with different rewards for a same content packet. For example, different reward rules may apply for two different alerts associated with a content packet, one of the alerts presenting a blinking version of an image and the other alert presenting a static version of the same image. In one embodiment, an alert with a statically displayed pattern is associated with rewards of lesser earned credits or a lesser coupon value compared with another alert with dynamically displayed pattern. A POP system may present content packet-3, content packet-4, and content packet-5 during periods 912, 916 and 920 to build time-based user loyalty in a similar manner as when during periods 904 and 908 for content packet-1 and content packet-2.

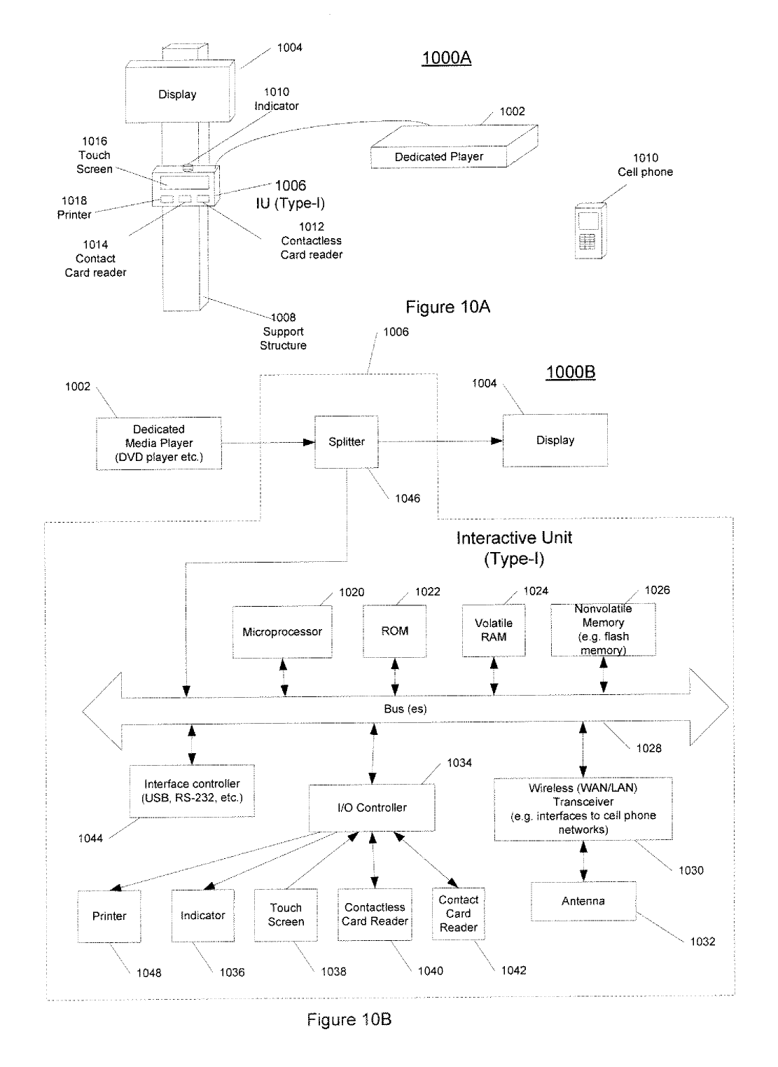

FIG. 10A illustrates an exemplary local point-of-presence system including a Type-I interactive unit according to one embodiment of the present invention. System 1000A may include a dedicated media-player 1002 coupled to a display 1004 through a Type-I interactive unit (IU) 1006. A dedicated media player 1002 may be a DVD player that does not have typical peripheral interface, such as USB port or COM port to communicate with other data devices. In one embodiment, a dedicated media-player 1002 is a single channel player, such as player 262 of FIG. 2, or a multi-channel player, such as player 268 of FIG. 2. A display 1004 may be a TV unit, such as display 264 of FIG. 2. A display 1004 and a Type-I interactive unit 1006 may be mounted on a supporting structure 1008 such as a wall or a shelf. An interactive unit, such as interactive unit 266, 276 or 278 of FIG. 2, may be a Type-I IU including a promotion indicator 1010, a contactless card reader 1012, a contact card reader 1014, a touch screen 1016, and a printer 1018.

FIG. 10B is a block diagram illustrating one embodiment of a Type-I interactive unit. A Type-I interactive unit 1006 may include a bus 1028 that is coupled to a microprocessor(s) 1020, a ROM (Read Only Memory) 1022, volatile RAM 1024, and a non-volatile memory 1026. The microprocessor 1020 may retrieve instructions from memories 1022, 1024, 1026 and execute the instructions to perform operations according to, for example, I/O controls modules 472, 474, 476 of FIG. 4. I/O components may include promotion indicator 1036, touch screen 1038, contactless card reader 1040, contact card reader 1042, and printer 1048. An I/O component may send and receive data from the microprocessor 1020 through I/O (input/output) controller 1034 and bus 1028. It should be noted that a typical contact or contactless card reader may perform both read and write operations.

Additionally, a wireless transceiver 1030 and its antenna 1032 may be coupled with a bus 1028 to provide an interface to a wireless WAN or LAN network. In one embodiment, the wireless transceiver 1030 is a cell-phone transceiver. An interface controller 1044 may allow a Type-I IU to communicate with other data devices, such as a computer. A splitter 1046 may receive output signals from a dedicated media player 1002, send an audio/video signal to a display 1004, and extract control packets encoded in vertical blanking interval (VBI) from outputs of the media player 1002.

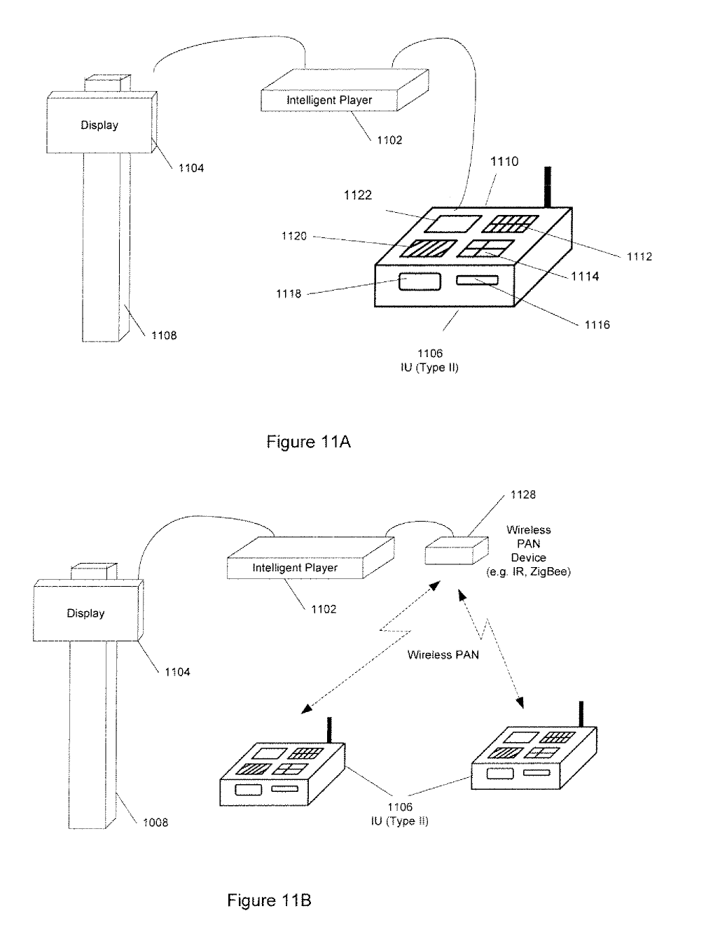

FIG. 11A illustrates an exemplary local point-of-presence system including a Type-II interactive unit according to one embodiment of the present invention. A local POP system, such as POP system 260 of FIG. 2, may include an intelligent media-player 1102 coupled to a display 1104 and a Type-II interactive unit 1106. A display 1104 may be a computer monitor or an HDTV (High Definition TV). An intelligent media player 1102 may be a digital computer. A display 1104 and a Type-II interactive unit 1106 may be mounted on a supporting structure 1008 such as a wall or a shelf. An interactive unit, such as interactive unit 266, 276 or 278 of FIG. 2, may be a Type-II IU including an indicator 1110, a keypad 1112, a touch screen 1114, a contact card reader 1116, a printer 1118, barcode scanner 1120, and a contactless card reader 1122.

FIG. 11B illustrates an exemplary local point-of-presence system including a wireless PAN (personal area network) according to one embodiment of the present invention. An intelligent media-player 1102 may be coupled to a display 1104 and a wireless PAN (Personal Area Network) device 1128. Multiple Type-II interactive units 1106 may communicate with each other wirelessly via a wireless PAN device 1128. A wireless PAN network may be an infrared, ZigBee, RFID (Radio Frequency Identification), or other near-field communication network.

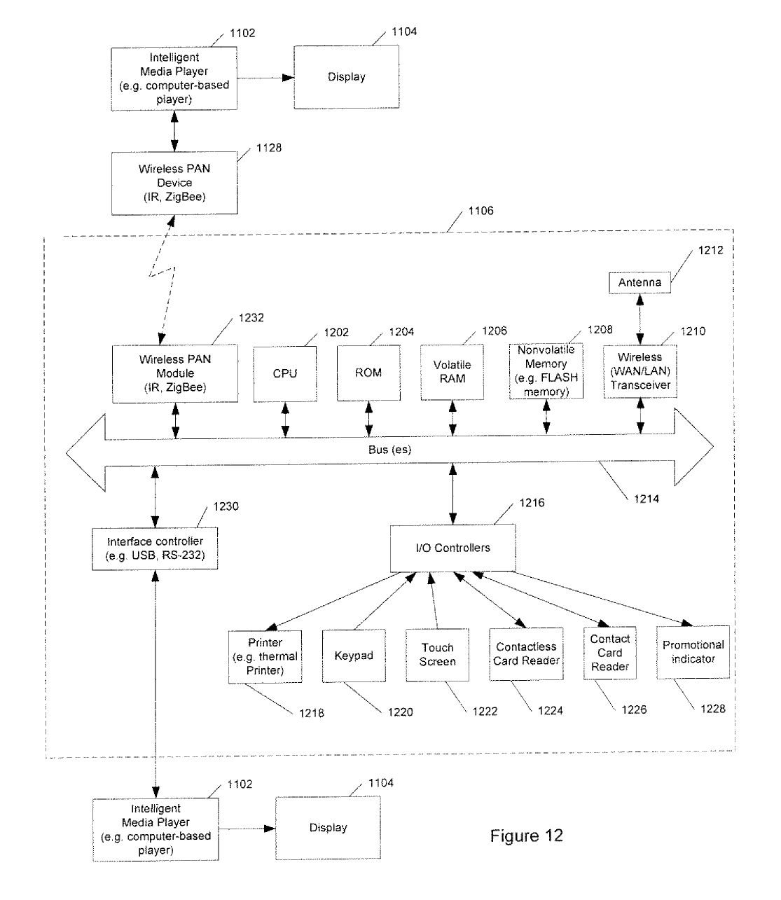

FIG. 12 is a block diagram illustrates one embodiment of a Type-II interactive unit. A Type-II interactive unit 1106 may include a bus 1214 coupled to a microprocessor(s) 1202, a ROM (Read Only Memory) 1204, a volatile RAM 1206, and a non-volatile memory 1208. The microprocessor 1202 may retrieve instructions from the memories 1204, 1206, 1208 and execute the instructions to perform operations according to, for example, I/O control modules 472, 474 or 476 of FIG. 2. Multiple I/O components, such as printer 1218, keypad 1220, touch screen 1222, contactless card reader 1224, contact card reader 1226, and/or promotion indicator 1228, may be coupled with the microprocessor 1202 through I/O (input/output) controller 1216 and bus 1214 for exchanging data.

Additionally, in FIG. 12, a wireless transceiver 1210 and its antenna 1212 may be coupled with bus 1214 to provide an interface to a wireless WAN or LAN network. In one embodiment, the wireless transceiver 1212 is a wireless LAN transceiver. An interface controller 1230 may enable Type-II IU 1106 to communicate with an intelligent media-player, such as media-player 1102 of FIG. 11A. A Type-II IU 1106 may also use a wireless PAN module 1232 to communicate with intelligent media-player 1102 through a wireless PAN device 1128.

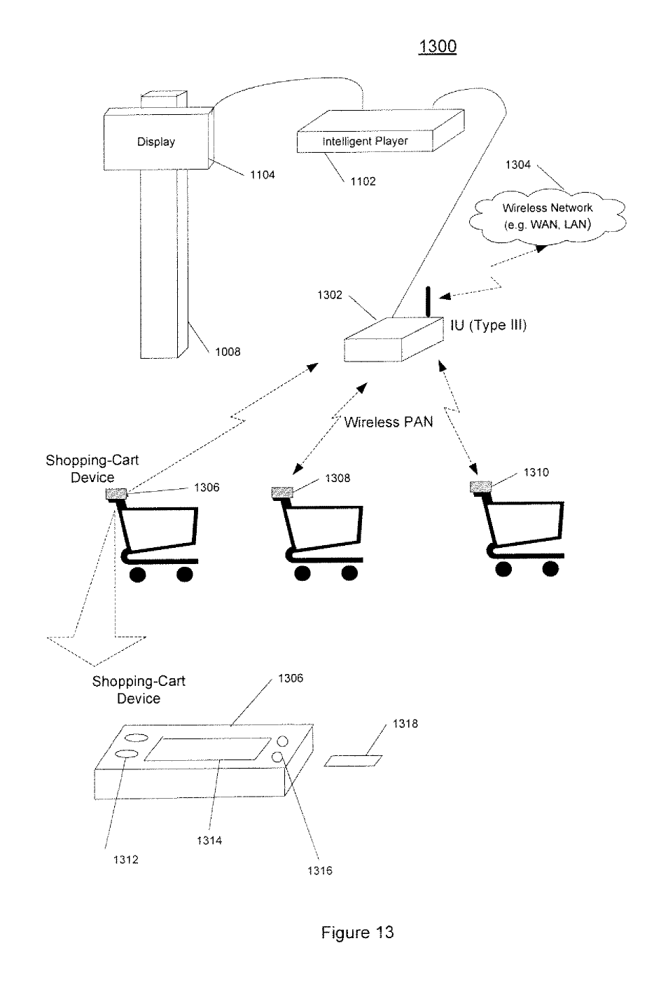

FIG. 13 illustrates an exemplary local point-of-presence system including a shopping-cart unit according to one embodiment of the present invention. System 1300 may include an intelligent media-player 1102 coupled with a display 1104 and a Type-III interactive unit 1302. A display 1104 may be a computer monitor or an HDTV. An intelligent media player 1102 may be a digital computer. A display 1104 and a Type-III interactive unit 1302 may be mounted on a supporting structure 1008, such as a wall or a shelf. A Type-III IU 1302 may include indicators and push buttons for system maintenance and reset.

In one embodiment, a Type-III interactive unit 1302 sends and receives data packet from shopping cart devices 1306, 1308, 1310 via a wireless PAN network. A shopping card device 1306 may retrieve ID and other user-related data from a contact or contactless membership card 1318, e.g. inserted by a shopper. A shopping card device 1306 may forward retrieved data to a Type-III interactive unit 1302 via a wireless PAN network. A membership card 1318 may also store user data locally inside, such as user credit points, records of issued rewards, or instant coupons. A shopping-cart device 1306 may include a touch screen 1314, buttons 1316, and promotional indicator 1312 to interface with a shopper.

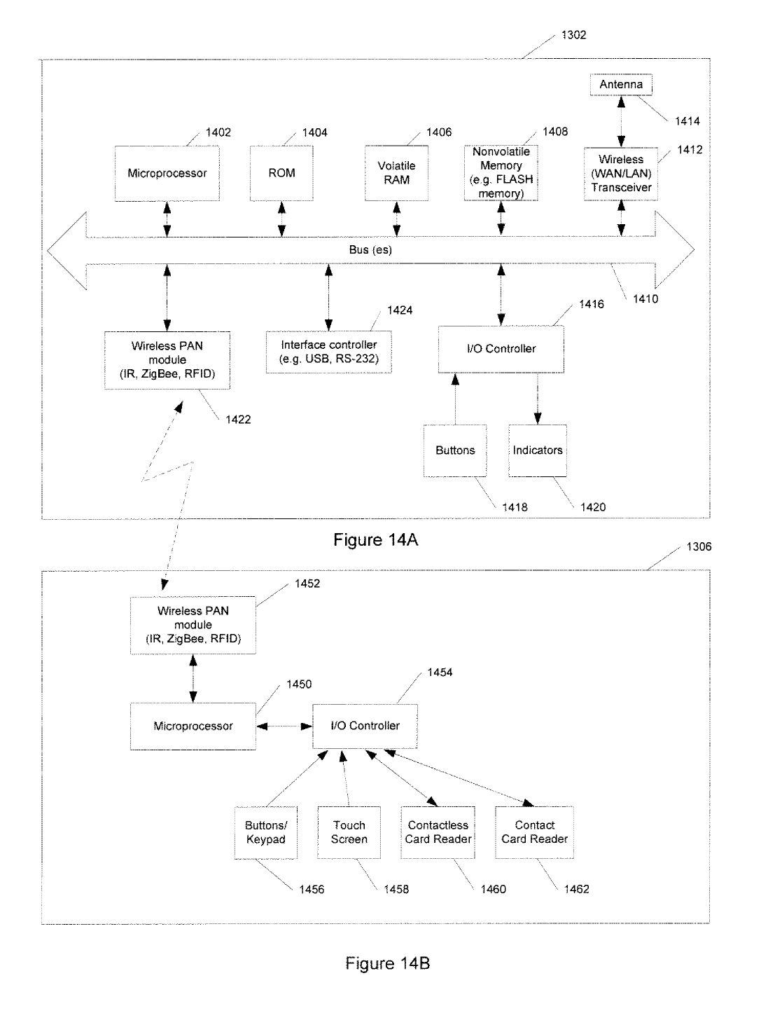

FIG. 14A is a block diagram illustrating one embodiment of a Type-III interactive unit. A Type-III interactive unit 1302 may include a bus 1410 coupled to a microprocessor(s) 1402, a ROM (Read Only Memory) 1404, a volatile RAM 1406, and a non-volatile memory 1408. A microprocessor 1402 may retrieve the instructions from the memories 1404, 1406, 1408 and execute the instructions to perform operations according to, for example, I/O control modules 472, 474 or 476 of FIG. 4. 110 components, such as buttons 1418 or light emitting indicators 1420, may send and receive data from a microprocessor 1402 through an 110 (input/output) controller 1416 and a bus 1410. A wireless transceiver 1412 and its antenna 1414 may be coupled with a bus 1410 to provide an interface to a wireless WAN or LAN network. In one embodiment, a wireless transceiver 1212 is a wireless LAN transceiver. An interface controller 1424 may enable a Type-III IU 1302 to communicate with an intelligent media player, such as media-player 1102 of FIG. 13. A Type-III IU 1302 may also communicate with shopping-cart unit 1306 via a wireless PAN module 1422.

FIG. 14B a block diagram illustrating one embodiment of a shopping cart device. A shopping-cart device 1306 may include a microprocessor 1450 coupled with I/O components via an 110 controller 1454. An I/O component, such as a buttons/keypad 1456, a touch screen 1458, a contactless card reader 1460, or a contact card reader 1462, may provide interface functions to interact with shoppers. A microprocessor 1450 may wirelessly communicate with a Type-III interactive unit 1302 via a wireless PAN module 1452.

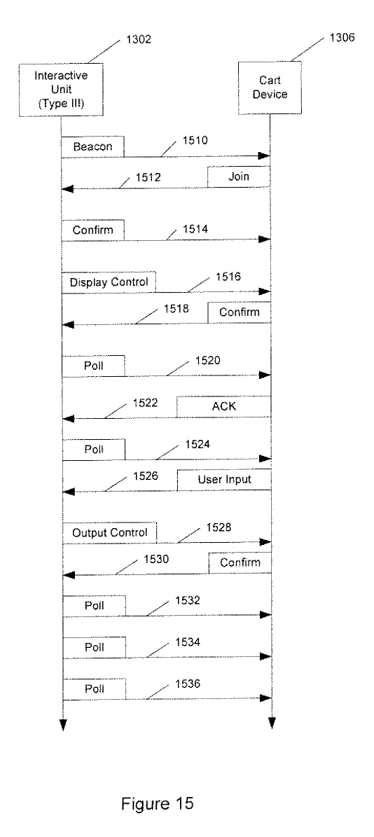

FIG. 15 is a sequence diagram illustrating one embodiment of a Type-III interactive unit polling a shopping-cart device within a PAN network. An IU, such as Type-III IU 1302 of FIG. 13, may communicate with a cart device, such as shopping-cart device 1306 of FIG. 13, via a wireless PAN based on passive RFID (radio frequency identification) technology. An RFID tag in a wireless PAN may communicate with an interrogator after receiving a polling data packet identifying the interrogator. In one embodiment, a Type-III IU 1302 sends beacon data packets over a wireless network to establish network connections (e.g. data sessions) with a cart device 1306 of FIG. 13. A card device 1306 may include a RFID tag responding to polling data packets sent by a RFID interrogator of Type-III IU 1302 over a wireless network.

At sequence 1510, according to one embodiment, a Type-III interactive IU 1302 may send a beacon packet to a shopping-card device (SCD) 1306 which may in turn send a responding packet to the IU 1302 for establishing a network connection at sequence 1512. IU 1302 may determine if SCD 1306 is authorized according to an identifier included in the responding packet from SCD 1306. If authorized, IU 1302 may send SCD 1306 a packet including confirmation information and network configuration data, e.g. related to a wireless PAN, at sequence 1514, followed by a separate data packet for display control at sequence 1516. A display control packet may include presentation instructions to drive a touch screen 1314 and promotion indicator 1316 in SCD 1306.

At sequence 1518, in one embodiment, SCD 1306 sends a confirm packet to IU 1302 via an established wireless network connection. A confirm packet may include a user ID and related information retrieved from a membership card 1318 of IU 1302. In one embodiment, IU 1302 continues sending polling packets to SCD 1306 at sequence 1520. SCD 1306 may respond with an acknowledge packet to indicate an established network connection is still alive. In one embodiment, SCD 1306 is positioned within a close neighborhood of IU 1302 for establishing a wireless network connection between SCD 1306 and IU 1302. Subsequent to collecting user inputs, at SCD 1306 may send a data packet including the collected user inputs to IU 1302 at sequence 1526 in response to a polling packet received at sequence 1524.

On receiving collected user inputs, IU 1302 may issue rewards for a user according to a set of rules, such as, for example, rule engine 466 of FIG. 4 based on the time user inputs were collected. At sequence 1528, IU 1302 may send a data packet including issued rewards to SCD 1306 to perform an output transaction for storing issued rewards, such as, for example, credit points or electronic coupons into user's membership card attached to SCD 1306. In one embodiment, SCD 1306 sends a data packet to IU 1302 at sequence 1530 for confirming the completion of an output transaction. Subsequently, IU 1302 may keep polling SCD 1306 at sequences 1532, 1534, and 1536. An established network connection between SCD 1306 and IU 1302 may be terminated if IU 1302 has not receive any acknowledge packet for a predetermined period of time, e.g. a time out period. SCD 1306 may stop receiving a polling data packet from IU 1302 when SCD 1306 is no longer in a neighborhood of IU 1302, has joined a separate IU, e.g. IU 1308 of FIG. 13, or determines to terminates a data session with IU 1306 for other reasons.

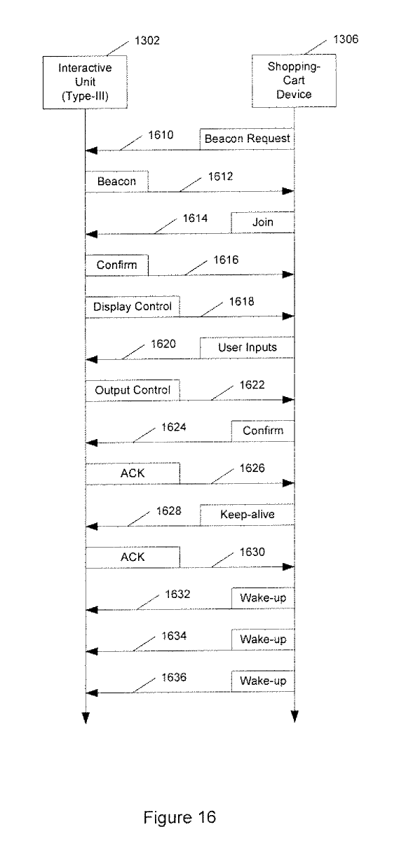

FIG. 16 a sequence diagram illustrating an example of initiating a communication session with a PAN network according to one embodiment of the present invention. An IU, such as Type-III IU 1302 of FIG. 13, may communicate with a cart device, such as shopping-cart device 1306 of FIG. 13, via a wireless PAN based on battery-powered ZigBee or Infrared system. In one embodiment, at sequence 1610, SCD 1306 broadcasts a beacon-request packet to IU 1302 over a wireless network. In response to receiving a beacon-request packet from SCD 1306, IU 1302 may send a beacon packet including information related to a wireless network, such as a wireless PAN, for establishing a network connection. At sequence 1614, SCD 1306 may send a data packet including collected user ID and/or user-related information for establishing a connection with IU 1302.

IU 1302 may determine whether to accept a network connection from SCD 1306, for example, based on received user information. If an acceptance is confirmed, IU 1302 may send SCD 1306 a data packet including confirmation and network configuration data, such as related to a wireless PAN at sequence 1616. Subsequently, at sequence 1618, IU 1302 may send a display control packet to SCD 1306. A display control packet may include instructions to drive a touch screen 1314 and/or a promotion indicator 1316 of the SCD 1306. After collecting user inputs, SCD 1306 may send a user input packet including user input data to IU 1302 at sequence 1620.

On receiving collected user inputs, IU 1302 may issue rewards for a user according to a set of rules, such as, for example, rule engine 466 of FIG. 4 based on the time user inputs were collected. At sequence 1622, IU 1302 may send an output control packet including issued rewards to SCD 1306 to perform an output transaction for storing issued rewards, such as, for example, credit points or electronic coupons into user's membership card attached to SCD 1306. In one embodiment, SCD 1306 sends a data packet to IU 1302 at sequence 1624 for confirming the completion of an output transaction. In response, IU 1302 may return an acknowledgement packet at sequence 1626. Subsequently, at sequence 1628, SCD 1306 may send a keep-alive packet to IU 1302 to indicate that SCD 1306 is still in IU 1302 neighborhood. At sequence 1630, IU 1302 may send an acknowledge packet to SCD 1306 to indicate an established wireless network connection is still alive. In one embodiment, SCD 1306 keeps sending keep-alive packet to IU 1302 at a predetermined interval to maintain established wireless connection with IU 1302. A network connection between SCD 1306 and IU 1302 may be terminated if IU 1302 has not received any keep-alive packet a predetermined period of time, e.g. a time out event. If SCD 1306 has not received any acknowledge packet for a certain period of time, SCD 1306 may keep sending wake-up packets to IU 1302, for example, at sequences 1632, 1634 and 1636. SCD 1306 may determine to terminate a network connection if no responses have been received alter sending a predetermined number of wake-up packets.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPIROMs, magnetic or optical cards, or any type of media suitable for storing electronic instructions, and each coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

What is claimed is:

1. A machine-implemented method for a point-of-presence system, comprising:
in response to receiving a presentation schedule for a multimedia content, determining a time window based on the presentation schedule;
playing the multimedia content according to the presentation schedule at a predetermined location;
presenting an interactive user interface pattern within a vicinity of the predetermined location during the time window; and
in response to receiving a user input by a user via the interactive user interface pattern, generating a reward, wherein the reward can be used by the user.

2. The method of claim 1, wherein the presentation of the multimedia content is accessible in the vicinity of the location.

3. The method of claim 1, wherein the multimedia content and the interactive user interface pattern are presented on a single device.

4. The method of claim 1, wherein the multimedia content is presented on a first device, wherein the interactive user interface pattern is presented on a second device, and wherein the first device and the second device are coupled via a wireless network.

5. The method of claim 4, wherein the predetermined location is a fixed location, wherein the first device is a stationed in the fixed location and wherein the second device is a mobile device in the vicinity of the predetermined location.

6. The method of claim 5, wherein the second device is coupled to a shopping cart in the vicinity of the predetermined location.

7. The method of claim 1, wherein the playing the multimedia starts at a start time, wherein the time window includes a delay time period, and wherein the time window starts later than the start time by at least the delay time period.

8. The method of claim 7, wherein the delay time period is at least several seconds.

9. The method of claim 7, wherein the time window overlaps with a duration of the playing the multimedia content.

10. The method of claim 1, wherein the receiving of the presentation schedule comprises:
in response to receiving data packets from a remote operation center, decoding from the data packets the multimedia content and control content; and
determining the presentation schedule based on the control content.

11. The method of claim 10, wherein the reward includes a value and where the generation of the reward comprises:
generating a set of rules for a rule engine according to the control content; and
executing the rule engine according to the set of rules to determine the value for the reward.

12. A machine-readable storage medium having instructions stored therein, which when executed, cause a machine to perform a method, the method comprising:
in response to receiving a presentation schedule for a multimedia content, determining a time window based on the presentation schedule;
playing the multimedia content according to the presentation schedule at a predetermined location;
presenting an interactive user interface pattern within a vicinity of the predetermined location during the time window; and
in response to receiving a user input by a user via the interactive user interface pattern, generating a reward during the time window, wherein the reward can be used by the user.

13. The medium of claim 12, wherein the time window includes a delay time period, further comprising:
repeating a number of times to play the multimedia content;
waiting for the delay time period for each of the number of times; and
repeating the number of times to present the interactive user interface pattern subsequent to the waiting for the delay time period.

14. The medium of claim 12, wherein the generation of the reward comprises:
collecting user information via the interactive user interface pattern; and
determining a value for the reward according to the user inform-nation and the multimedia content.

15. The medium of claim 14, further comprising:
printing an instant coupon authorized to redeem the value for the user.

16. The medium of claim 14, wherein the user information includes a cell phone number of the user, the method further comprising:
establishing a wireless connection with a cell phone device associated with the cell phone number; and
sending the reward as a credit of the determined value to the cell phone device via the wireless connection.

17. The medium of claim 14, wherein the interactive user interface pattern includes a blinking image.

18. The medium of claim 12, further comprising:
in response to receiving data packets from a remote operation center, decoding from the data packets the multimedia content and control content; and
determining the presentation schedule based on the control content.

19. The medium of claim 18, wherein the reward includes a value and wherein the generation of the reward comprises:
generating a set of rules for a rule engine according to the control content; and
executing the rule engine according to the set of rules to determine the value for the reward.

20. A point-of-presence system comprising:
a memory unit including instructions;
a processing unit coupled to the memory unit through a bus to execute the instructions; and
a presentation unit coupled to the processing unit through the bus to play a multimedia content according to a presentation schedule, wherein the instructions include:
a decoding module to determine a time window based on the presentation schedule;
a control module to present an interactive user interface pattern within a vicinity of a location of the point-of-presence system during the time window; and
a rule engine module to generate a reward in response to a user input via the interactive user interface pattern during the time window.
